(19) United States
(12) Patent Application Publication
(10) Pub. No.: US 2006/0143292 A1
(43) Pub. Date: Jun. 29, 2006

(54) Location-based network access

(76) Inventors: David B. Taubenheim, Plantation, FL (US); Edgar H. Callaway JR., Boca Raton, FL (US); Stephen T. Machan, Oakland Park, FL (US)

Correspondence Address: MOTOROLA, INC., 1303 EAST ALGONQUIN ROAD, IL01/3RD, SCHAUMBURG, IL, 60196, US

(21) Appl. No.: 11/024,381

(22) Filed: Dec. 28, 2004

(51) Int. Cl. G06F 15/173

(52) U.S. Cl. 709/225

(57) ABSTRACT

When a candidate node (104) wishes to join a network (100), network access is either allowed or denied based on the candidate node's physical location. More particularly, a plurality of nodes associated with the network aide in locating the candidate node. Once located, a decision is made to either allow or deny network access based on the candidate node's physical location.

### FIELD OF THE INVENTION

The present invention relates generally to network access, and in particular, to secure, location-based network access.

### BACKGROUND OF THE INVENTION

As more and more network devices access networks via wireless transmission/reception, the chance that unscrupulous users will attempt to gain access to any secure network only increases. While existing techniques for secure network access exist, these techniques may not be adequate to protect against unauthorized network access via wireless transmission/reception. For example, if an unscrupulous user gains access to an individual's laptop computer, the user may use the laptop's internal authentication procedures to gain access to the secure network. Because the user can access the network wirelessly, the user can attempt to gain access from a remote location, outside of any brick-and-mortar security systems. Therefore a need exists for a method and apparatus for accessing a network that is secure enough to prevent wireless access from undesired locations.

### BRIEF DESCRIPTION OF THE DRAWINGS

FIG. 1 is a block diagram of a wireless network.

FIG. 2 is a block diagram of a wireless node from FIG. 1.

FIG. 3 is a block diagram of a processing node of FIG. 1.

FIG. 4 is a flow chart showing operation of a node granting or denying access to the network of FIG. 1.

FIG. 5 is a flow chart showing operation of candidate nodes wishing to join the network of FIG. 1.

FIG. 6 is a flow chart showing operation of the processing node of FIG. 1.

FIG. 7 is a block diagram of a wireless network.

### DETAILED DESCRIPTION OF THE DRAWINGS

To address the above-mentioned need a method and apparatus for network access is provided herein. More particularly, when a candidate node wishes to join a network, network access is either allowed or denied based on the candidate node's physical location. A plurality of nodes associated with the network aide in locating the candidate node. Once located, a decision is made to either allow or deny network access based on the candidate node's physical location.

Because access may be restricted to nodes existing within certain physical regions, access to a particular network can be restricted, for example, to nodes inside a physical area such as perimeter wall. By restricting access to nodes outside geographic areas, network security is greatly increased.

The present invention encompasses a method for location-based network access. The method comprises the steps of receiving a wireless request from a candidate node for network access, determining a physical location parameter for the candidate node, and allowing or denying network access based on the physical location of the candidate node.

The present invention additionally encompasses a method comprising the steps of receiving a plurality of location parameters transmitted from a plurality of nodes associated with a network and determining a location of a candidate node based on the received location parameters. A a geographic area of restricted access is determined. It is also determined if the location of the candidate node is within the geographic area of restricted access. Finally a message indicating whether the candidate node is allowed or denied access is transmitted based on whether the candidate node is within the geographic area or restricted access.

The present invention encompasses an apparatus comprising a receiver receiving a plurality of location parameters, location-finding equipment determining a location of a node based on the location parameters, and logic circuitry for determining a restricted geographic area, and determining if the location of the node is within the restricted geographic area. A transmitter is also provided for transmitting a message allowing or denying network access for the node based on the whether or not the node is within the restricted geographic area.

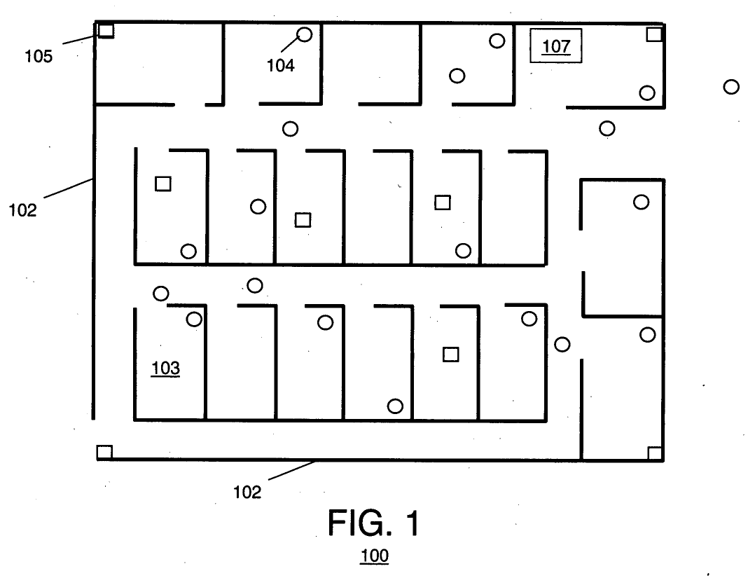

Turning now to the drawings, wherein like numerals designate like components, FIG. 1 is a block diagram of wireless network 100. In a preferred embodiment of the present invention network 100 comprises an ad-hoc network such as a neuRFon™ network available from Motorola, Inc. that utilizes the neuRFon™ communication system protocol. Other possible forms for network 100 include, but are not limited to, networks utilizing the ZigBee™, IEEE 802.11™, HiperLAN™, or HiperLAN/2™ protocols.

As shown, wireless network 100 is superimposed on a floor plan of an interior of an office building, with perimeter wall 102 enclosing a plurality of offices 103 (only one office labeled). Although shown in a two-dimensional setting one of ordinary skill in the art will recognize that wireless network 100 may exist in any physical two or three-dimensional location. Wireless network 100 includes a number of wireless nodes 104, 105, and 107 involved in determining node location in a centralized manner.

Circular objects 104 (only one labeled) represent wireless devices, nodes, remote, or mobile units, the locations of which may vary and are not known prior to the performance of a location-determining process. Such devices include, but are not limited to, lap top computers, wireless communication devices including cellular telephones, wireless sensors, etc. Wireless nodes 104 can be associated with network 100 (not authenticated) in that the network will accept certain command messages related to an authentication routine. Wireless nodes 104 can also be authenticated in that they have been allowed access to network 100 and are allowed to transmit and receive data messages.

Rectangular objects 105 (only one labeled) represent reference nodes similar to wireless nodes 104 except that the locations of reference nodes 105 are known prior to the performance of any location-determining process. Further, reference nodes 105 may be dedicated location-determining nodes that transmit location data, but do not receive. Wireless nodes 104 and reference nodes 105 are utilized in determining the locations of any candidate node 104 wishing to gain access to network 100. In a preferred embodiment of the present invention processing node 107 is provided, comprising location-finding equipment (LFE) to perform calculations involved in determining the location of any candidate node in a centralized manner as will be described below in more detail.

As described above, as more and more network devices access networks via wireless transmission/reception, the chance that unscrupulous users will attempt to gain access to any secure network only increases. In order to address this issue, the location of nodes attempting to access network 100 is determined prior to the granting of network access privileges. In a preferred embodiment of the present invention, nodes which do not physically exist within one or more predetermined regions are not allowed to associate with the network. Because access is restricted to nodes that exist within certain physical regions, access to a particular network can be restricted, for example, to nodes inside a physical area such as perimeter wall 102.

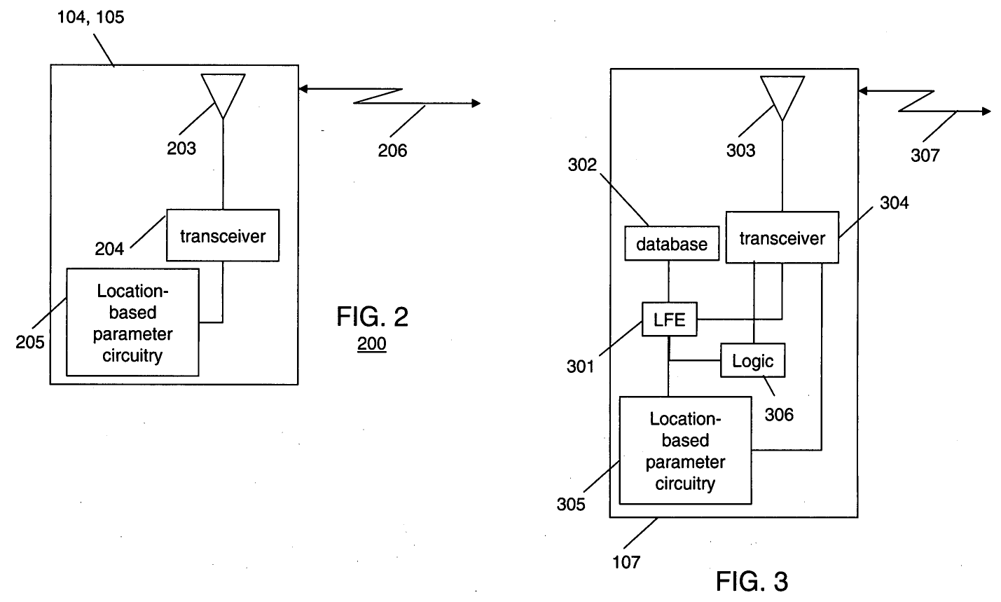

FIG. 2 is a block diagram of a wireless node 200 which may act as node 104 or reference node 105. When performing the functions of a standard node 104, node 200 determines the value of at least one location-based parameter of the signals received from other wireless nodes 104, reference nodes 105, or processing nodes 107, and provides data related to this parameter to processing node 107 for location determination in a centralized manner. A “location-based parameter” is any property of a received signal that may be used to infer the location of one or more nodes in network 100.

As shown wireless node 200 is equipped with antenna 203 transmitter/receiver (transceiver) 204, and location-based parameter circuitry 205. When wireless node 200 wishes to determine a node's location, it receives over-the-air communication signal 206 transmitted from the node to be located. In a preferred embodiment, signal 206 comprises a nonce that uniquely identifies signal 206; the nonce may comprise a time stamp that identifies the time at which signal 206 was sent. Once received by transceiver 204, the processed signal 206 (and the nonce, if present) is passed to location-based parameter circuitry 205.

If location-based parameter circuitry 205 is utilizing a signal-strength technique to determine location information, location-based parameter circuitry 205 determines a signal strength value and passes a value related to this signal strength to processing node 107 via transceiver 204. In a similar manner, if location-based parameter circuitry 205 is utilizing a time-of-arrival technique to determine location information, location-based parameter circuitry 205 determines a time-of-arrival value and passes a value related to this time-of-arrival value to processing node 107. Finally, if location-based parameter circuitry 205 is utilizing an angle-of-arrival technique to determine location information, location-based parameter circuitry 205 determines an angle-of-arrival value and passes a value related to this angle-of-arrival value to processing node 107. One of ordinary skill in the art will recognize that other techniques to determine location information, including but not limited to the use of the described techniques in combination, are also possible and fall within the scope of the present invention.

As discussed above, node 200 may additionally act as a reference node. As discussed, the locations of reference nodes 105 are known prior to the performance of any location-determining process. Further, reference nodes 105 may be dedicated location-determining nodes that transmit location data, but do not receive. Thus transceiver 204 may not receive, operating as a transmitter only. When acting as a reference node, transceiver 204 transmits signal 206 from time to time, providing location information to at least one other node in network 100. This location information preferably comprises the node's location, which can be used to calibrate any node aiding in location.

In an alternative embodiment, transceiver 204 operates as both a transmitter and receiver, with node 200 responding to received requests from at least one other node in network 100 to transmit location information. In yet another embodiment, transceiver 204 operates as both a transmitter and receiver, and optional location-based parameter circuitry 205 is coupled to transceiver 204. In this embodiment, node 200 provides location information and communication services in a manner similar to that of a wireless node, the difference being that the location of reference node 105 is known prior to the performance of a location-determining process.

FIG. 3 is a block diagram of processing node 107. Processing node 107 serves to locate any node wishing to access network 100. As shown, processing node 107 is equipped with antenna 303 location-finding equipment (LFE) 301, database 302, logic circuitry 306, and location-based parameter circuitry 305. Although shown coexisting within node 107, LFE 301 and database 302 may also be physically remote from node 107 and, for example, connected via a local-area network or the Internet.

As discussed above, processing node 107 may be solely utilized for location estimation and granting access to network 100 in a centralized manner. In an alternative embodiment, many processing nodes 107 may be placed in network 100, operating as wireless nodes 104 except that processing nodes 107 are also equipped at least to perform a location-determining function and grant network access in a distributed manner. During operation, transceiver 304 receives communication signal(s) 307 via antenna 303, from at least one of nodes 104, 105, and 107. Location-based parameter circuitry 305 analyzes the signal(s) 307 and generates location-based parameters contained within the signal(s). This information is then passed to LFE 301, which stores it in database 302. LFE 301 then utilizes the information in database 302 to determine the location of one or more wireless nodes, either in network 100 (wireless nodes 104, reference nodes 105, and other processing nodes 107) or candidate nodes attempting to access network 100. While the exact method for locating a node is immaterial to this discussion, in a preferred embodiment of the present invention a signal strength technique is utilized as described in U.S. Pat. No. 6,473,078, “Method and Apparatus for Location Estimation,” by Patwari, et al.

Finally, logic circuitry 306 determines a geographic area of restricted access (possibly stored in database 302) and determines if the location of the candidate node is within the geographic area of restricted access. Logic circuitry 306 instructs transceiver 304 to transmit a message indicating whether the candidate node is allowed or denied access based on whether the candidate node is within the geographic area or restricted access. As discussed, access may be allowed when the node is located within a building and denied when the node is located outside the building.

Network 100, equipped as described above, will have the resources necessary to allow and deny network access based on criteria including the location of any node requesting access. Although various access techniques may be utilized, in a preferred embodiment of the present invention, a modified version of the access technique described in ZigBee Alliance Document 03322r12, “Security Services Specification”, is utilized. As described in the ZigBee document, a device may request access to network 100 by issuing a network discovery request (NLME-NETWORK-DISCOVERY), which results in the transmission of a beacon request command. When a member of network 100 hears the request, it will transmit a beacon to the candidate node requesting access. The beacon will identify network 100, along with its security level and frame attributes. In reply, the candidate node transmits an association request command. Other devices in network 100, such as wireless nodes 104, reference nodes 105, and processing nodes 107, that are within range of the candidate node also receive the association request command, and determine the location parameter of the candidate node (as discussed above). When location is determined in a centralized manner, devices that overheard the association request command sent by the candidate node, forward at least a value related to the received signal strength to processing node 107, along with the address of the device to which the association request command was sent. Processing node 107 then estimates the location of the candidate device, by performing a location-estimation algorithm in LFE 301.

Once located, the candidate node is either granted or denied access to the network based on its location; this decision may be made by processing node 107, the node to which the association request command was made, or one or more other nodes in the network. Regardless of where the decision was made, the decision is sent to the node to which the association request command was made. If access is given to the candidate node, the candidate node is sent an affirmative association response command in reply to its association request command. The candidate node is then considered to be associated (joined) to network 100, but not yet authenticated. The authentication procedure only proceeds for those candidate nodes allowed network access.

ZigBee has allows for several different authentication procedures. In the preferred embodiment of the present invention the procedure invoked when the candidate node 104 has a preconfigured network key is employed. More particularly, after a candidate node receives the affirmative association response command, it receives a transport-key command, transporting a dummy network key containing all zeros. At this point it is authenticated, and may now function as a member of network 100 using the network key stored in it at some earlier time.

If the candidate node is denied access to the network based at least in part on its estimated location, it is informed in a negative association response command, sent in reply to its association request command. The candidate node then cannot begin an authentication procedure, and cannot function as a member of network 100. Note that a candidate can be refused network access even if it has a preconfigured network key and therefore is cryptographically capable of operating in network 100. This is useful, for example, to reduce the potential for abuse of mass-produced items that, to reduce manufacturing cost and increase usability by inexperienced users, are produced with the same preconfigured network key.

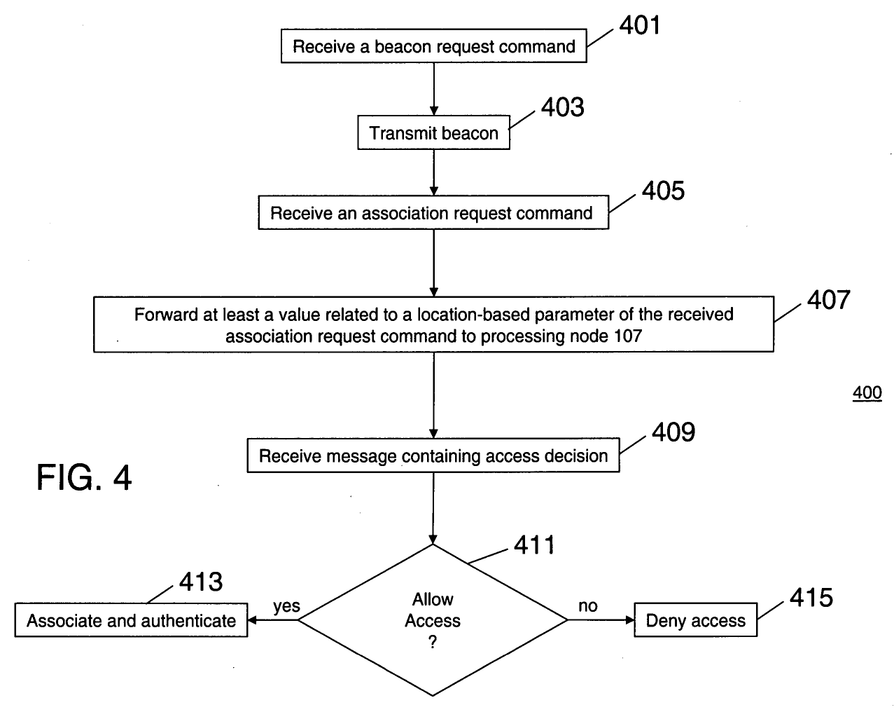

FIG. 4 is a flow chart showing operation of wireless node 104 granting or denying network 100 access to a node requesting access (e.g., a candidate node). The logic flow begins at step 401 where transceiver 204 receives a beacon request command from the candidate node. At step 403, transceiver 304 transmits a beacon in reply to the received beacon request command. In response, an association request command message is received via transceiver 204 from the candidate node requesting network access (step 405). As discussed, this association request command message is received by other devices in network 100, which determine at least a value related to a location-based parameter of the message and forward that information to processing node 107, along with the address of the node to which the association request command message was sent.

At step 407 parameter circuitry 205 determines at least a value related to a location-based parameter of the association request command message and forwards that information (via transceiver 204) to processing node 107, which determines a physical location of the candidate node. As discussed, the location parameter may comprise such parameter as a signal strength parameter, an angle-of-arrival parameter, a time-of-arrival parameter, . . . , etc.

Continuing, at step 409, transceiver 204 receives a message from processing node 107 containing the access decision. At step 411, wireless node 104 processes this decision, which is based on the physical location of the node. If at step 411, access is allowed, association is permitted and association and authentication proceeds (step 413), otherwise access is denied (step 415). Step 415 may consist of simply failing to reply to the candidate node, or alternatively by transmitting a message notifying it that access has been denied. One skilled in the art recognizes that the above steps may repeat for the candidate node or other candidate nodes wishing to access the network.

Although the above logic flow was executed with processing node 107 making an allow/deny decision, in an alternative embodiment, at step 409 wireless node 104 may receive a message from processing node 107 that contains the location estimate of the candidate node. In this embodiment, wireless node 104 will make the access decision at step 411, based at least in part on the location estimate.

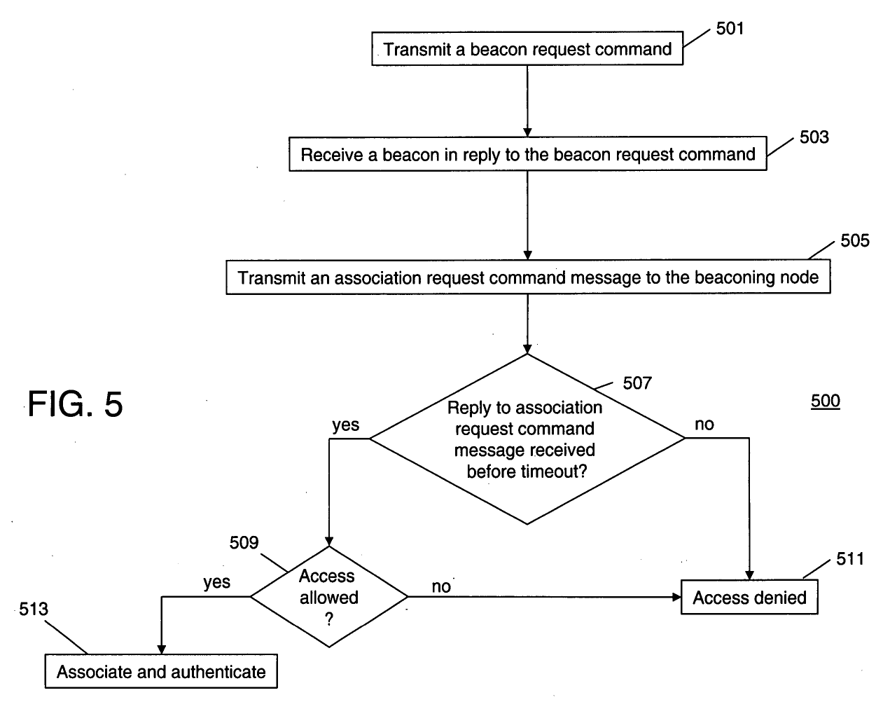

FIG. 5 is a flow chart showing operation of node 104 requesting access to network 100. The logic flow begins at step 501 where a beacon request command is transmitted by transceiver 204. At step 503 a beacon is received in reply to the beacon request command. At step 505 an association request command message is transmitted by transceiver 204 to the beaconing node. At step 507, the candidate node determines if a reply to the association request command message is received within a predetermined period of time. If a reply is not received in time, the candidate node determines that access has been denied and the logic flow ends at step 511. However, if at step 507 the candidate node determines that a reply to the association request command message has been received in time, the candidate node evaluates the contents of the reply at step 509. If the candidate node is allowed to access network 100, the logic flow continues to step 513 where the association and authentication procedure takes place, otherwise the logic flow ends at step 511 with a denial of access. One skilled in the art recognizes that the above steps may repeat for the candidate node or other candidate nodes wishing to access the network.

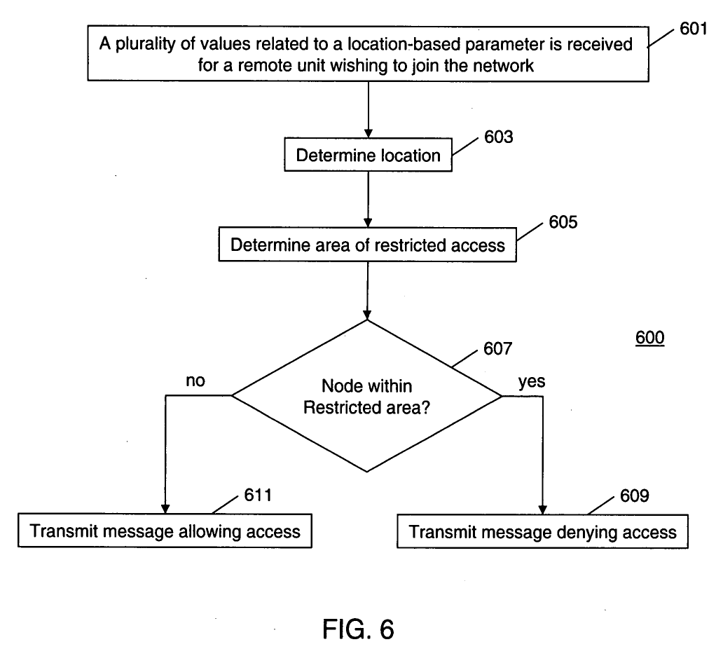

FIG. 6 is a flow chart showing operation of processing node 107. The logic flow begins at step 601 where a plurality of location-based parameters is received. Also received at step 601 is the address of the candidate node to which the location-based parameters are related. As discussed above, the values related to a location-based parameter originate from nodes within network 100, with the nodes assisting in locating the candidate node.

At step 603 a location is determined for the candidate node requesting access and at step 605 an area of restricted access, is determined by logic circuitry 306. At step 607 logic circuitry 306 determines if the candidate node lies within the area of restricted access. If the candidate node lies within the area of restricted access, a message is transmitted, indicating that access to network 100 should be denied (at step 609). If, however, at step 607 it is determined that the candidate node is not within the area of restricted access, the logic flow continues to step 611 where a message is transmitted indicating that access to network 100 should be permitted.

In the preferred embodiment of the present invention the information sent in step 609 and 611 is transmitted to the node that received the association request, however, in an alternative embodiment, the information sent in steps 609 and 611 is transmitted to all nodes in network 100. Thus, all nodes will become aware of the status of the candidate node. This is useful in the event a candidate node that has been denied access attempts to access the network by contacting a different network node. Should that occur, the new contacted node may then immediately deny access to the candidate node, without the need to repeat the location determination procedure described above. Candidate node status is of course time-sensitive, due to the possibility that it has moved, and after a period of time the location procedure must be repeated upon access request.

As discussed, the above procedure allows network access based on the physical location of the candidate node. Because of this, network access may be restricted to those candidate nodes within a physical structure, and denied to those outside the structure.

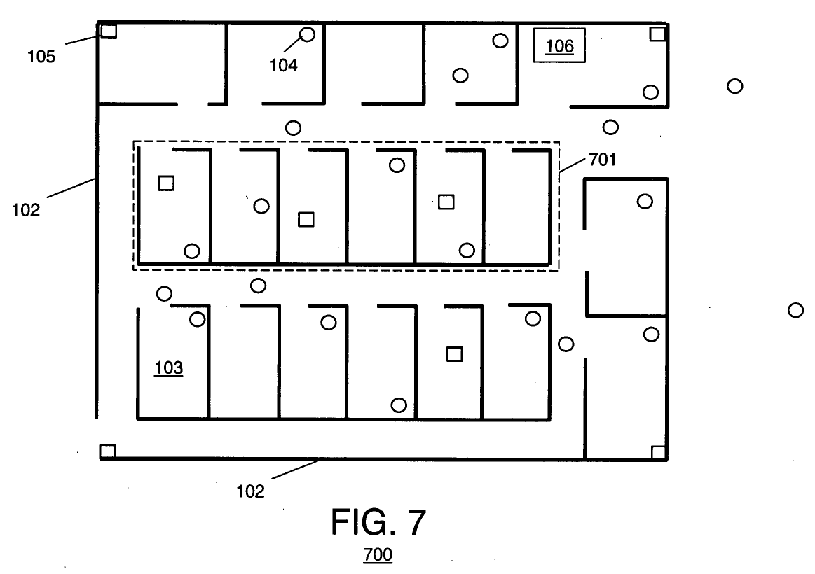

It should be noted that areas of restricted access are not specifically limited to areas outside of perimeter wall 102. For example, all nodes within certain areas of a building may be excluded from accessing a particular network. This is illustrated in FIG. 7, where the restricted area lies outside region 701. Thus, as shown in FIG. 7, only certain offices are allowed access to network 100. Those offices outside of region 701 may be denied access.

While the invention has been particularly shown and described with reference to a particular embodiment, it will be understood by those skilled in the art that various changes in form and details may be made therein without departing from the spirit and scope of the invention. It is intended that such changes come within the scope of the following claims.

1. A method for location-based network access, the method comprising the steps of:
receiving a wireless request from a candidate node for network access;
determining a physical location parameter for a signal received from the candidate node; and
allowing or denying network access based on the physical location of the candidate node.

2. The method of claim 1 further comprising the steps of:
reporting the physical location parameter to location finding equipment; and
receiving a location of the candidate node.

3. The method of claim 1 further comprising the steps of:
reporting the physical location parameter to location finding equipment; and
receiving a message indicating whether the candidate node is allowed access to the network.

4. The method of claim 1 wherein the step of determining the location parameter comprises the step of determining a signal strength parameter.

5. The method of claim 1 wherein the step of determining the location parameter comprises the step of determining a time-of-arrival parameter.

6. The method of claim 1 wherein the step of determining the location parameter comprises the step of determining an angle-of-arrival parameter.

7. The method of claim 1 wherein the step of allowing or denying network access based on the physical location of the node comprises the step of allowing access when the node is located within a building and denying access when the node is located outside the building.

8. The method of claim 1 further comprising the step of:
transmitting a message to the candidate node informing the candidate node that network access is permitted.

9. A method comprising the steps of:
receiving a plurality of location parameters transmitted from a plurality of nodes associated with a network;
determining a location of a candidate node based on the received location parameters;
determining a geographic area of restricted access;
determining if the location of the candidate node is within the geographic area of restricted access; and
transmitting a message indicating whether the candidate node is allowed or denied access based on whether the candidate node is within the geographic area or restricted access.

10. The method of claim 9 wherein the step of the plurality of location parameters comprises the step of receiving a plurality of signal strength parameters.

11. The method of claim 9 wherein the step of the plurality of location parameters comprises the step of receiving a plurality of time-of-arrival parameters.

12. The method of claim 9 wherein the step of the plurality of location parameters comprises the step of receiving a plurality of angle-of-arrival parameters.

13. The method of claim 9 wherein the step of transmitting the message comprises the step transmitting a message allowing access when the node is located within a building and transmitting a message denying access when the node is located outside the building.

14. An apparatus comprising:
a receiver receiving a plurality of location parameters;
location-finding equipment determining a location of a node based on the location parameters;
logic circuitry for determining a restricted geographic area, and determining if the location of the node is within the restricted geographic area; and
a transmitter transmitting a message allowing or denying network access for the node based on the whether or not the node is within the restricted geographic area.

15. The apparatus of claim 14 wherein the location parameters comprise signal strength parameters.

16. The apparatus of claim 14 wherein the location parameters comprise time-of-arrival parameters.

17. The apparatus of claim 14 wherein the location parameters comprise angle-of-arrival parameters.

18. The apparatus of claim 14 wherein the message allows access when the node is located within a building and denies access when the node is located outside the building.
